(19) United States
(12) Patent Application Publication
(10) Pub. No.: US 2009/0125307 A1
(43) Pub. Date: May 14, 2009

(54) System and a method for providing each user at multiple devices with speaker-dependent speech recognition engines via networks

(76) Inventor: Jui-Chang Wang, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/979,945

(22) Filed: Nov. 9, 2007

(51) Int. Cl. G10L 17/00; G10L 21/00

(52) U.S. Cl. 704/246; 704/270; 704/E17.001; 704/E17.015; 704/E21.001

(57) ABSTRACT

A system and a method for providing each user at multiple devices with speaker-dependent speech recognition engines via networks according to the pre-stored speech sounds and characteristics of devices, by which each user can use speaker-dependent speech recognition engines in different devices without the need of repeating the same procedure of recording speech to train speech recognition engines for newly utilized devices.

### BACKGROUND OF THE INVENTION

1. Field of the Invention

The present invention relates to a speech recognition system and a method and, more particularly, to a system and a method for providing each user at multiple devices with speaker-dependent speech recognition engines via networks.

2. Description of the Prior Art

Speech recognition technology is the most convenient way to operate various electronic devices, such as desktop computers, notebook computers, mobile phones, or personal digital assistants. Users input directly their speech sounds via audio input devices such as microphones, and their speech sounds can be converted into words or even commands further. By this way, users can operate these various electrical devices or input words conveniently by speaking. For example, users can edit articles into computers or dial someone via mobile phones by giving orally the commands. In addition to bringing convenience to general speakers, the speech recognition technology is even more valuable and indispensable to the handicapped or to some speakers who suffer from muscular atrophy.

Generally, speech recognition engines of the speech recognition technology can be categorized into two kinds: speaker-dependent speech recognition engines and speaker-independent speech recognition engines.

Users can utilize speaker-independent speech recognition engines directly without the need of training the engines before using them because a large amount of speech sounds by many other speakers are pre-stored for the model training. However, the precision rate of speaker-independent speech recognition engines is much worse than that of speaker-dependent ones because pronunciations from different speakers may vary significantly.

When using speaker-dependent speech recognition engines, speakers have to train or adapt speech recognition engines in advance. In other words, the speech recognition engines cannot be produced before the speakers' speech sounds are acquired. For example, when speakers want to use speech-dialing function of mobile phones, they have to record their speech sounds concerning information like receivers' names in the beginning. Therefore, it is inconvenient for speakers to adopt speaker-dependent speech recognition engines even though the precision rate of them is higher. In other words, when speakers have endeavored training speaker-dependent speech recognition engines in the electronic devices they currently use and they want to utilize new electronic devices, they have to repeat the same procedure of training speaker-dependent speech recognition engines in the new electronic devices. For example, if users start to utilize new mobile phones, they have to record their speech sounds into the new mobile phones again for the purpose of training speaker-dependent speech recognition engines in the new mobile phones.

Electronic devices are used widely nowadays and it is common for users to own different electronic devices at the same time. As mentioned above, the recorded speech sounds for training a speaker-dependent speech recognition engine in one electronic device cannot be applied to the training of speaker-dependent speech recognition engines in the other devices. Therefore, users have to repeat recording their speech sounds for training speaker-dependent speech recognition engines in different electronic devices. It is time-consuming and gradually speech recognition will become less attractive for users. On the contrary, if the training of speaker-dependent speech recognition engines can be easy and the highly accurate speaker-dependent speech recognition engines are widely adopted, it is probable to see much more useful speech recognition applications than now. In order to solve the problems mentioned above, inventor had the motive to study and develop the present invention after hard research. The invention comprises a speech recognition engine-producing system and a method that provide speaker-dependent speech recognition engines via networks and avoid inconvenient repetition of the training routine work. Moreover, by long-term accumulation of speech sounds recorded in different devices via networks, higher precision rates of speech recognition can further be achieved.

### SUMMARY OF THE INVENTION

An object of the present invention is to provide a system and a method for providing each user at multiple devices with speaker-dependent speech recognition engines via networks according to the pre-stored speech sounds and characteristics of devices, by which each user can use speaker-dependent speech recognition engines in different devices without the need of repeating the same procedure of recording speech to train speech recognition engines for newly utilized devices.

Another object of the present invention is to continuously improve the accuracy of speech recognition engines by accumulatively collecting speech sounds of the users via networks.

In order to achieve the above objects, the present invention provides a system and a method for providing each user at multiple devices with speaker-dependent speech recognition engines via networks, wherein the system comprises a storage unit and a speech recognition engine-producing unit. The storage unit is used for storing recorded speech sounds of each user. The speech recognition engine-producing unit is used to generate speaker-dependent engines for each user to utilize in different devices according to the stored speech sounds of the user and the characteristics of the devices in use.

In addition, the method in the present invention comprises the following steps:

a. recording each user's speech sounds by a device in use, transferring and storing the recorded speech sounds into a storage unit of a system provided in a platform that is connected with networks; and

b. producing a speaker-dependent speech recognition engine suitable for the device by means of a speech recognition engine-producing unit according to the stored speech sounds and the characteristics of the device.

Thereby, in any device, a user can directly use a speaker-dependent speech recognition engine that is produced according to the pre-stored speech sounds of the same speaker and the characteristics of the device without the need to proceed with the same procedure of recording speech to train the speech recognition engine in advance.

The following detailed description, given by way of examples and not intended to limit the invention solely to the embodiments described herein, will be understood best in conjunction with the accompanying drawings.

### BRIEF DESCRIPTION OF THE DRAWINGS

FIG. 1 is a schematic view showing a first embodiment of a system for providing each user at multiple devices with speaker-dependent speech recognition engines via networks according to the present invention.

FIG. 2 is a schematic view of a second embodiment of a system for providing each user at multiple devices with speaker-dependent speech recognition engines via networks according to the present invention.

FIG. 3 is another schematic view of the second embodiment of a system for providing each user at multiple devices with speaker-dependent speech recognition engines via networks according to the present invention.

FIG. 4 is another schematic view of the second embodiment of a system for providing each user at multiple devices with speaker-dependent speech recognition engines via networks according to the present invention.

FIG. 5 shows a flow chart of a method for providing each user at multiple devices with speaker-dependent speech recognition engines via networks according to the present invention.

### DETAILED DESCRIPTION OF THE PREFERRED EMBODIMENTS

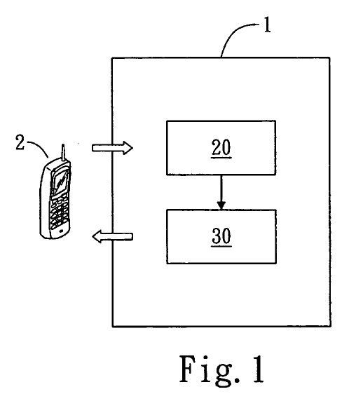

FIG. 1 shows a first embodiment of a system for providing each user at multiple devices with speaker-dependent speech recognition engines via networks according to the present invention. As shown in FIG. 1, the system is set up in a platform 1 in networks and comprises a storage unit 20 and a speech recognition engine-producing unit 30. The storage unit 20 is used for storing a user's speech sounds recorded by a mobile phone 2. The speech recognition engine-producing unit 30 is used for generating a speaker-dependent engine for the user to utilize in the mobile phone 2 according to the stored speech sounds of the user and the characteristics of the mobile phone 2.

Moreover, the speech recognition engine-producing unit 30 is designed to generate speaker-dependent engines according to the stored speech sounds by means of model training techniques or model adaptation techniques. Each produced speech recognition engine includes a feature-extraction element for extracting acoustic parameters from speech sounds, a set of trained model parameters for pattern recognition, and a search element to perform pattern recognition. In addition, it is also necessary to take into considerations the software or hardware of devices in use in order to make the produced speech recognition engines suitable for the devices.

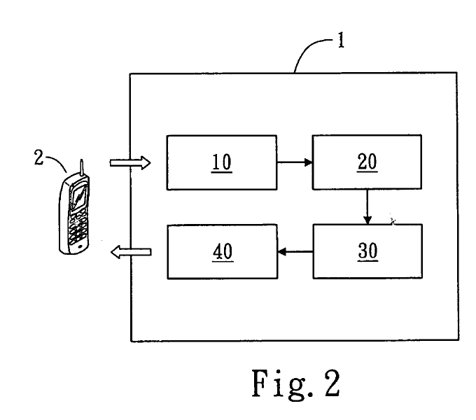

FIG. 2 is a schematic view showing a second embodiment of a system for providing each user at multiple devices with speaker-dependent speech recognition engines via networks according to the present invention. The system is set up in a platform 1 in the networks and comprises a login unit 10, a storage unit 20, a speech recognition engine-producing unit 30, and an engine-download unit 40.

The login unit 10 is for different users to enter the system via networks by any devices having speech recognition function. The storage unit 20 is used for storing each user's speech sounds recorded by the devices. The speech recognition engine-producing unit 30 is used for generating speaker-dependent engines for the user to utilize in the device according to the stored speech sounds of the user and the characteristics of the device. The engine-download unit 40 is used for users to download the produced speech recognition engines into the devices in use to utilize speaker-dependent speech recognition function.

As shown in FIG. 2, when a user utilizes a mobile phone 2, the user can record speech sounds by using an audio-signal receiving device disposed within the mobile phone 2. The recorded speech sounds can be transferred and stored in the storage unit 20 via networks after the user enters the system via the login unit 10 provided in a platform 1 that is connected with networks. Then, the speech recognition engine-producing unit 30 is able to generate speaker-dependent speech recognition engines according to the stored speech sounds and the characteristics of the device in use. The generated speaker-dependent speech recognition engine can be downloaded into the mobile phone 2 via the engine-download unit 40 provided in the system.

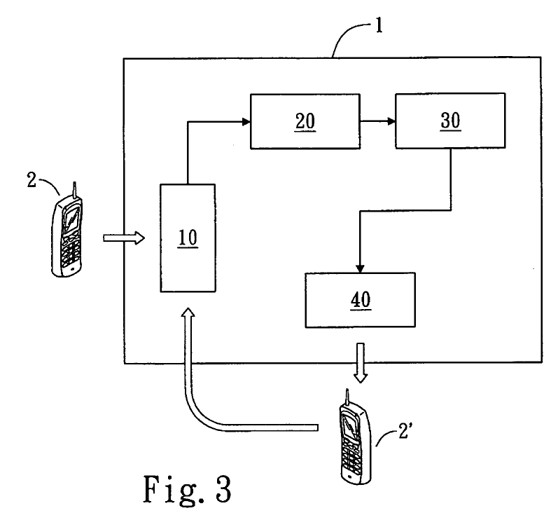

FIG. 3 is another schematic view showing the first embodiment of the system for providing each user at multiple devices with speaker-dependent speech recognition engines via networks according to the present invention. As shown in FIG. 3, the user transfers and stores speech sounds into the storage unit 20 by utilizing the mobile phone 2. When the user wants to utilize another mobile phone 2′, the user can enter and register information concerning the mobile phone 2′ into the speech recognition engine-producing system via the login unit 10. Then the user can transfer and store a small amount of speech sounds recorded in the mobile phone 2′ into the storage unit 20 for representing the characteristics of the mobile phone 2′. Therefore, a speaker-dependent speech recognition engine suitable for the new mobile phone 2′ can be produced by the speech recognition engine-producing unit 30 according to the speech sounds pre-stored and characteristics of the mobile phone 2′. The produced speech recognition engine can be downloaded into the mobile phone 2′ finally by the engine-download unit 40 via networks. By this way, users can utilize speech recognition function in any new device without the need of repeating the same procedure of recording speech to train speaker-dependent speech recognition engines for any new devices. Besides, users can still transfer and store speech sounds by utilizing the new mobile phone 2′ into the storage unit 20 to accumulate the speech sounds continuously. Accordingly, the precision rate of speech recognition of the new mobile phone 2′ can be improved and the efficiency of producing speaker-dependent speech recognition engines for any other devices can also be improved in the same way.

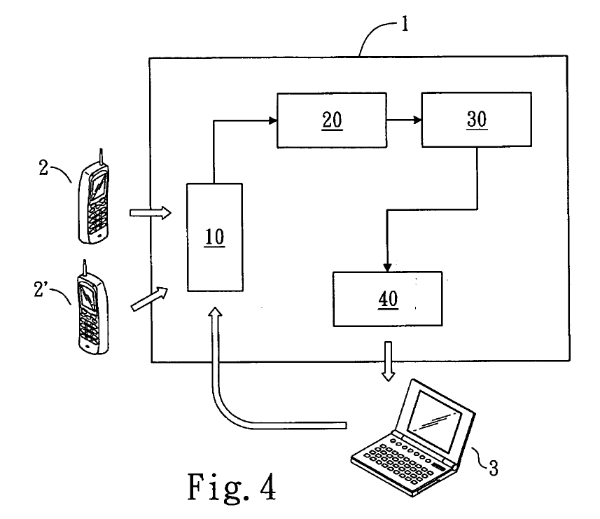

The stored speech sounds from one kind of devices used previously can be used in another kind of devices used currently. As shown in FIG. 4, the user establishes relevant information, transfers and stores speech sounds recorded in the mobile phones 2 and 2′ into the storage unit 20 via networks. When the user wants to use the speech recognition function in a notebook computer 3, the user can establish the information concerning the notebook computer 3 via the login unit 10 and transfer and store a small amount of recorded speech sounds into the storage unit 20 for representing the characteristics of the notebook computer 3. The speech recognition engine-producing unit 30 can produce a speaker-dependent speech recognition engine according to the stored speech sounds recorded from the mobile phones 2,2′ and the characteristics of the notebook computer 3. Finally, the produced speech recognition engine is downloaded by means of the engine-download unit 40 into the notebook computer 3 via networks. Accordingly, users can utilize speech recognition function in the notebook computer 3 without the need of repeating the same procedure of recording speech to train the speaker-dependent speech recognition engine for the notebook computer 3. Users can also transfer speech sounds by utilizing the notebook computer 3 into the storage unit 20 to accumulate the stored speech sounds continuously. The precision rate of speech recognition in the notebook computer 3 can be improved and the efficiency of producing speaker-dependent speech recognition engines for other devices can also be improved by this way.

As mentioned above, the system according to the present invention is set up in the platform 1 in the networks. The platform 1 can be set up in certain portal sites, such as Google, Yahoo, Apple, or Microsoft Network, so users can accumulate and utilize their speech sounds more conveniently. At the same time, the portal sites having the system of the present invention can attract and keep more users.

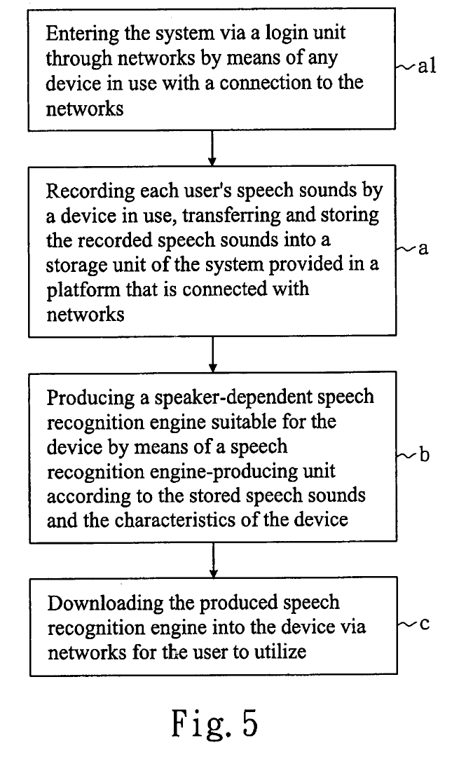

FIG. 5 is a flow chart of a method for providing each user at multiple devices with speaker-dependent speech recognition engines via networks according to the present invention. The method of the present invention comprises the following steps:

a1. entering the system via a login unit through networks by means of any device in use with a connection to the networks;

a. recording each user's speech sounds by a device in use, transferring and storing the recorded speech sounds into a storage unit of the system provided in a platform that is connected with networks;

b. producing a speaker-dependent speech recognition engine suitable for the device by means of a speech recognition engine-producing unit according to the stored speech sounds and the characteristics of the device; and

c. downloading the produced speech recognition engine into the device via networks for the user to utilize.

In the device used currently or any other new devices, the speech sounds of the user can continuously be recorded, transferred and stored into the storage unit 20 via networks. New speaker-dependent speech recognition engines can be produced by the speech recognition engine-producing unit 30 according to the stored speech sounds and the characteristics of devices in use.

Moreover, the devices used in the system and the method according to the present invention can be, but not limited to, mobile phones, desktop computers, notebook computers, or personal digital assistants. And the networks used in the system and the method according to the present invention can be, but not limited to, computer networks, mobile communication networks, or fixed-line communication networks

Thereby, the present invention has the following advantages:
1. By using the system and the method for providing each user at multiple devices with speaker-dependent speech recognition engines via networks according to the present invention, speaker-dependent speech recognition engines can be produced for any devices according to pre-stored speech sounds and the characteristics of devices in use without the need of repeating the same procedure of recording speech sounds to train speaker-dependent speech recognition engines.
2. By using the system and the method for providing each user at multiple devices with speaker-dependent speech recognition engines via networks according to the present invention, users are able to accumulate their individual speech sounds continuously to improve the efficiency of producing speaker-dependent speech recognition engines for any other devices and make them more accurate in recognition for individual users.
3. By setting up the system according to the present invention on any portal site in the networks, users can accumulate and utilize their speech sounds more conveniently and efficiently. At the same time, the portal sites having the system providing with the speaker-dependent speech recognition engines can attract and keep more users.

Accordingly, as disclosed in the above description and attached drawings, the present invention can provide a system and a method for providing each user at multiple devices with speaker-dependent speech recognition engines via networks. And by this way users can conveniently utilize speaker-dependent speech recognition engines in different devices and accumulate their speech sounds continuously to improve the efficiency of producing the speaker-dependent speech recognition engines for any new devices. Therefore, the system can make the speech recognition engines more accurate for individual users. The invention is novel and can be put into industrial use.

It should be understood that different modifications and variations could be made from the disclosures of the present invention by the people familiar in the art, which should be deemed without departing the spirit of the present invention.

What is claimed is:

1. A system for providing each user at multiple devices with speaker-dependent speech recognition engines via networks, comprising:
a storage unit for storing each user's speech sounds recorded via devices; and
a speech recognition engine-producing unit for generating speaker-dependent engines, for the user to utilize in the devices, according to the stored speech sounds of the user and the characteristics of the devices.

2. The system as claimed in claim 1, further includes a login unit for different users to enter the system via networks by using devices having speech recognition function.

3. The system as claimed in claim 2, further includes an engine-download unit for users to download the produced speech recognition engines into the devices in use to utilize speaker-dependent speech recognition function.

4. The system as claimed in claim 1, further includes an engine-download unit for users to download the produced speech recognition engines into the devices in use to utilize speaker-dependent speech recognition function.

5. The system as claimed in claim 1, wherein the device is a desktop computer, a notebook computer, a mobile phone, or a personal digital assistant.

6. The system as claimed in claim 1, wherein the networks are computer networks, mobile communication networks, or fixed-line communication networks.

7. The system as claimed in claim 1, wherein the speech recognition engine-producing unit is designed to generate speaker-dependent engines according to the stored speech sounds of said user and the characteristics of said devices by model training techniques or model adaptation techniques.

8. A method for providing each user at multiple devices with speaker-dependent speech recognition engines via networks, comprising following steps:
a. recording each user's speech sounds by a device in use, transferring and storing the recorded speech sounds into a storage unit of a system provided in a platform that is connected with networks; and
b. producing a speaker-dependent speech recognition engine suitable for the device in use by means of a speech recognition engine-producing unit according to the stored speech sounds of the user and the characteristics of the device.

9. The method as claimed in claim 8 further includes a step a1 before step a:
a1. entering the system via a login unit through networks by means of any device in use with a connection to the networks.

10. The method as claimed in claim 9 further includes a step c after step b:
c. downloading the produced speech recognition engine into said device via networks for the user to utilize.

11. The method as claimed in claim 8 further includes a step c after step b:
c. downloading the produced speech recognition engine into said device via networks for the user to utilize.

12. The method as claimed in claim 8, wherein the device is a desktop computer, a notebook computer, a mobile phone, or a personal digital assistant.

13. The method as claimed in claim 8, wherein the networks are computer networks, mobile communication networks, or fixed-line communication networks.

14. The system as claimed in claim 8, wherein the speaker-dependent speech recognition engine is produced by the stored speech sounds of said user and the characteristics of said devices according to model training techniques or model adaptation techniques.
